(19) United States
(12) Patent Application Publication
(10) Pub. No.: US 2010/0110467 A1
(43) Pub. Date: May 6, 2010

(54) System and Method of Rasterizing PDF Files using Multiple Processors

(76) Inventors: Paul A. Coniglio, East Amherst, NY (US); Robert D. Doyle, Tonawanda, NY (US); Nancy A. Lee, East Amherst, NY (US); William D. Romanowich, Williamsville, NY (US); Pam Liu, Williamsville, NY (US); Travis J. Galoppo, Grand Island, NY (US); Theodore F. Cyman, Grand Island, NY (US)

Correspondence Address: MCCRACKEN & FRANK LLP, 311 S. WACKER DRIVE, SUITE 2500, CHICAGO, IL, 60606, US

(21) Appl. No.: 12/614,158

(22) Filed: Nov. 6, 2009

Related U.S. Application Data
(60) Provisional application No. 61/198,635, filed on Nov. 6, 2008.

(51) Int. Cl. G06F 3/12

(52) U.S. Cl. 358/1.13; 358/1.15

(57) ABSTRACT

A plurality of pages represented by a page description language file are rasterized using a plurality of raster image processors. A server provides instructions for each raster image processor which of the plurality of pages to generate a raster image. The plurality of raster image processors generates raster images for the plurality of pages. A print controller sends press commands to a press controller, wherein the press controller operates a press in accordance with the press commands to print the raster images.

### CROSS REFERENCE TO RELATED APPLICATIONS

The present application claims benefit of provisional U.S. Patent Application No. 61/198,635 filed Nov. 6, 2008, the entirety of which is incorporated herein by reference.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to systems and methods for rasterizing page description language files, and more particularly for rasterizing such files in preparation for printing.

2. Description of the Background of the Invention

Composition software such as QuarkXpress® and InDesign®, developed by Quark, Inc. and Adobe Systems, Inc., respectively, enable a document designer to specify the content that is to appear on one or more pages of a document. Thereafter, the composition program generates a representation of the pages of the document in accordance with a page description language (PDL) such as PostScript or Portable Document Format (PDF) developed by Adobe Systems, Inc., or Printer Command Language (PCL) developed by Hewlett Packard, Inc. A raster image processor (RIP) generates a raster image representation of each page of the document from the PDL representation. The raster image representation may be used by a plate maker to image plates that are used on lithographic presses, an engraver to create engraved cylinders for a gravure press, or by a controller to drive the print units in a digital press. The raster image representation may be bitmap representation (e.g., one bit per pixel), a grayscale representation, or a color representation.

If a document incorporates variable data then the designer may use the composition software to create a template that specifies content of the fixed portion of the document (i.e., those portions that are not variable) and information regarding the position and content of variable data areas. The designer may use composition software that is specialized for creating the template. Alternately, the designer may use a composition program such as InDesign® or QuarkXPress® with a plug-in or an XTension (a type of plug-in that works with by QuarkXPress®) to specify information regarding variable data areas of a document. An example of a composition system that may be used to create templates is described in Warmus et al., U.S. Pat. No. 6,327,599, that is incorporated herein by reference. A data system may be used to combine information from a database with the template to generate PDL representations of the pages that represent the renditions of the variable data documents. The PDL representations may be in PostScript or PDF as described above or in formats (languages) designed to facilitate representation of renditions of variable data documents such as PPML, PPML/VDX, VPS, etc. The PDL representation may also be in page description languages based on PostScript or PDF that extend such formats through additional operators or libraries.

A RIP uses the PDL representation of the pages generated by the data system to create raster image representations of the pages for printing on a digital press. Such raster image representations are thereafter sent to one or more controllers in the press. The press controllers use the raster image representations to control printing by the press. The digital press may use any of number of printing technologies including electrophotography, ion deposition, magnetography, ink jet, or the like.

### SUMMARY OF THE INVENTION

According to an aspect of the present invention, a system for rasterizing pages in a page description language file includes a first RIP and a second RIP and a server that sends the page description language file and instruction data to the first RIP and the second RIP. The first RIP rasterizes a first portion of the pages in the page description language file and the second RIP rasterizes a second portion of the pages in the page description language file, wherein the first portion and the second portion are selected in accordance with the instruction data.

According another aspect of the present invention, a method for rasterizing pages in a page description language file includes the steps of sending the page description language file and instruction data to a first RIP and a second RIP. The method also includes the steps of operating the first RIP to rasterize a first portion of the pages in the page description language file in accordance with the instructions and operating the second RIP to rasterize a second portion of the pages in the page description language file in accordance with the instruction data.

Other aspects and advantages of the present invention will become apparent upon consideration of the following detailed description.

### BRIEF DESCRIPTION OF THE DRAWINGS

FIG. 1 comprises a block diagram of a printing system according to the present disclosure;

FIG. 2 comprises a flowchart of programming executed by the printing system of FIG. 1 to implement an embodiment of the print-on-command server of such Figure;

FIG. 3 comprises a flowchart of programming executed by the printing system of FIG. 1 to implement an embodiment of the print-server of such Figure;

FIG. 3A comprises a flowchart of programming executed by the printing system of FIG. 1 to implement an embodiment of the queue manager of such Figure;

FIG. 4 comprises a flowchart of programming executed by the printing system of FIG. 1 to implement an embodiment of a raster image processor (RIP) of such Figure;

FIG. 5 comprises a block diagram of another embodiment of the printing system shown in FIG. 1.

### DETAILED DESCRIPTION OF THE PREFERRED EMBODIMENTS

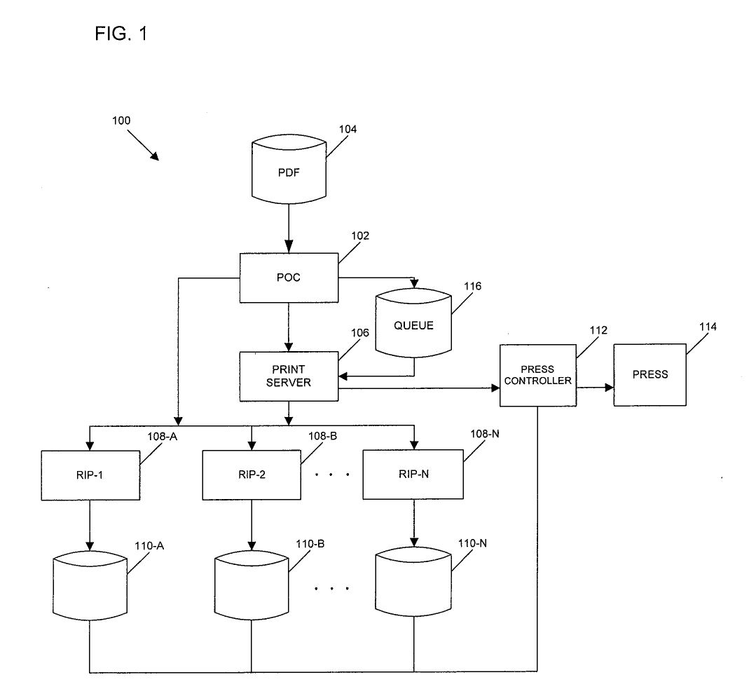

FIG. 1 shows a printing system 100 comprising a print-on-command server 102. The print-on-command server receives PDF documents (or documents encoded in accordance with another PDL) that are to be printed and stores each received document in a repository 104 associated therewith. In some embodiments the print-on-command server may be similar to the system described in Cyman et al., U.S. Patent Application Publication No. 2008/0239366, the disclosure of which is incorporated herein by reference.

The PDF file received by the print-on-command server specifies one or more pages to be printed using a printing press 114, typically a multiple-color (e.g., four-color) printing press. One example of such a printing press is described in Cyman et al., U.S. Provisional Patent Application Ser. No. 60/765,353, the disclosure of which is incorporated herein by reference.

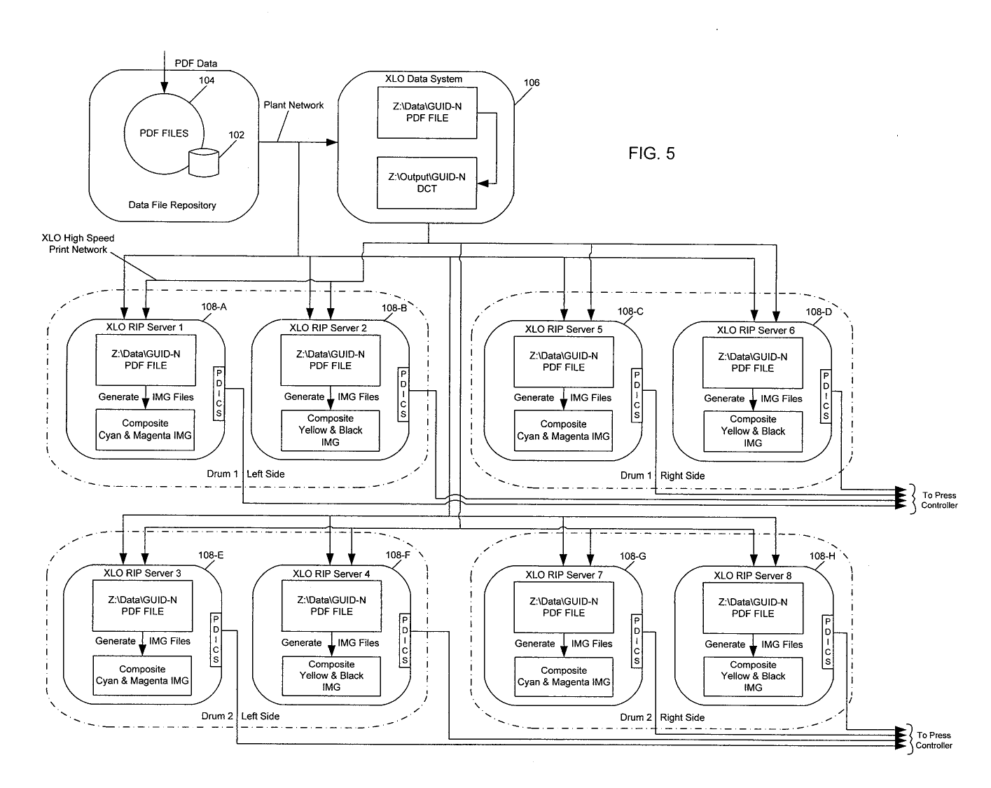

Continuing with FIG. 1, the print-on-command server 102 generates print-server instruction data that are sent to a print server 106 along with the PDF file. The XLO system referred to hereinbelow in FIG. 5 is an example of an embodiment of the print server 106 that may be used with the print system 100.

The print-on-command system 102 generates raster image processor (RIP) instruction data and transmits such data and the PDF file to be rasterized to all of a plurality of RIPS 108-A through 108-N that are to rasterize such PDF file. Each RIP 108-A through 108-N is pre-configured to generate a raster image corresponding to one color that is printed by the printing press 114. For example, if the printing press 114 prints using cyan, magenta, yellow, and black colored inks, then each RIP 108-A through 108-N is pre-configured to produce a raster image corresponding to one of these four colors. As is described hereinbelow, more than one RIP 108-A through 108-N may produce raster data corresponding to a single color.

In some embodiments the RIP instruction data may be generated externally and provided to the print-on-command server 102 with the PDF file to be printed. In other embodiments both the RIP instruction data and the print server instruction data may be generated externally and provided to the print-on-command server 102 with the PDF file to be printed, wherein the RIP instruction data and print server instruction data are in one file (e.g., a PDF file). In still other embodiments the RIP instruction and/or the print server instruction data may be generated externally and included as objects in the PDF file that is to be printed. In such cases, the print-on-command server 102 extracts and formats, as necessary, the RIP instruction data and the print server instruction data prior to sending such data to the print-server 106 or the RIPs 108-A through 108-N. In some cases identical RIP instruction data may be generated and sent to each of the RIPs 108-A through 108-N, wherein such instruction data have information for each RIP 108-A through 108-N.

The instruction data sent to a particular RIP 108-A, 108-B, . . . or 108-N specify the pages that are to be rasterized by such RIP. For example, the instruction data sent to the RIP 108-A may specify that such RIP is to rasterize every even page comprising the PDF file. In addition, the instruction data sent to the RIP 108-B may also specify that such RIP is to rasterize every even page in the PDF file. Further, instruction data sent to RIPs 108-C and 108-D may specify that such RIPs are to rasterize only the odd pages comprising the PDF file. In this manner, the RIPs 108C and 108-D rasterize PDF pages corresponding to the “front” of a book or document and the RIPs 108-A and 108-B raster PDF pages corresponding to the “back” of a book or document, if such pages appear in the PDF file in reading order.

Each page rasterized by a RIP 108-A through 108-N generates a raster image that is assigned a unique name and stored on a storage device (for example, a high-capacity disk array such as a RAID array) 110-A through 110-N associated with each of the RIPs 108-A through 108-N, respectively. In some embodiments, the unique name used by the RIP 108-A through 108-N for a particular color and page of the PDF file is specified in the instruction data provided to the RIP 108-A through 108-N. In other embodiments, the unique name used by the RIP 108-A through 108-N for the particular color and page of the PDF file is specified using metadata embedded in the PDF file or the page that is being rasterized. In other embodiments, the unique name is generated by the RIP 108-A through 108-N and is based on an identifier associated with the RIP 108-A through 108-N, the color, and the sequence number of the page in the PDF being rasterized.

In addition, each RIP 108-A through 108-N notifies the print-on-command server 102 identifying the page of the PDF file rasterized by the RIP 108-A through 108-N and, optionally, the unique name of the raster image generated from the page. After all of the pages of the PDF file have been rasterized (in all of the colors) the print-on-command server 102 generates a job ready signal that is sent to the print-server 106.

Upon receiving the print-server instruction data and the PDF from the print-on-command server 102, the print server 106 generates press commands in accordance with the pages in the PDF file. Such press commands may also be referred to as DCT files or DCT data in some embodiments and herein. For example, if the printing-press 114 prints using cyan, magenta, yellow, and black inks, four sets of press commands are generated by the print-server 106 and sent to the press controller 112 via a queue 116, one for each color. The press commands include the unique names that reference the raster image files that have been generated by the RIPs 108-A through 108-N and provide the sequence in which such files should be printed by the printing press 114. The unique names used by the print-server to refer to the raster image files are determined in a manner identical to that used by the RIPs 108-A through 108-N described above. The press commands generated for a particular color to be printed by the printing press direct the press controller to retrieve a raster image file corresponding to such color for each page of the PDF file. Specifically, the press commands specify the raster image using the unique name provided to the raster image file generated by one of the RIPs 108-A through 108-N. Thereafter the print-server 106 waits for the signal from the print-on-command server 102 that all of the pages of the PDF file have been rasterized by the RIPs 108-A through 108-N and adds the press commands to the queue 116.

A queue manager that may be part of the print-server retrieves the press commands from the queue 116 and sends them to the press controller 112.

In some embodiments, the printing press 114 may use multiple print units to print one side of a page. For example, the printing press 114 may print on a web of paper that is 18-inches wide using two adjacent 9-inch print units (for example, a “left” print unit and a “right” print unit) for each color printed by the printing press 114. In such cases, one of the RIPs 108-A through 108-N (for example, RIP 108-A) may be designated to generate raster data for a particular color for the left print unit and another one of the RIPs 108-A through 108-N (for example, RIP 108-B) may be designated to generate raster data for the particular color for the right print unit. In some embodiments, the RIPs 108-A through 108-N designated to generate the raster data for a left print unit and a right print unit may each generate data for the entire page (i.e., for example the entire 18-inch width of the web). The press controller 112 may select and send only the raster data required by the left print unit (i.e., the nine-inches to be printed by the left print unit) from the raster data generated by the RIP (e.g., the RIP 108-A) designated to generated the raster data for the left print unit.

In some embodiments, the print on command server 102 may assign a batch of pages in a PDL file to be rasterized by one of the RIPs 108-A through 108-N and another batch of pages to be rasterized by another one of the RIPs 108-A through 108-N. For example, the print on command system may divide a PDF representing 800 pages into four batches of 200 pages. A first batch representing pages 1 through 200 may be assigned to RIP 108-A, a second batch representing pages 201 through 300 may be assigned to RIP 108-B, and so on.

Dividing the pages in a PDL file into batches may be combined with instructing a RIP 108-A through 108-N to process only even or odd pages. For example, the print on command server 102 may instruct one of the RIPs 108-A through 108-B to rasterize the even pages in a first batch and another one of the RIPs 108-A through 108-B to rasterize the odd pages in the first batch. For example, a PDL file representing 800 pages may be divided into four batches of 200 pages each. The print on command may instruct RIP 108-A to rasterize the even pages of a first batch comprising pages 1 through 200 and RIP 108-B to raster the odd pages of such batch. That is, RIP 108-A rasterized pages 2, 4, 6, . . . , 200 and RIP 108-B rasterized pages 1, 3, 5, . . . , 199. Similarly, the print on command server may instruct RIPs 108-C and 108-D to rasterize the even and odd pages, respectively, of another batch comprising pages 201 through 300. Additional batches may be assigned in a similar fashion depending on the number of RIPs 108-A through 108-N available.

In the above example, the print on command server 102 may instruct RIPs 108-A and 108-B to store the raster images generated thereby for the batch of pages 1 through 200 to a common storage device (for example, the storage device 110-A associated with RIP 108-A) so that all of the images associated with a batch may be retrieved from a single storage location. The unique names of the raster images generated by RIP 108-B include a reference to the storage device associated with RIP 108-A.

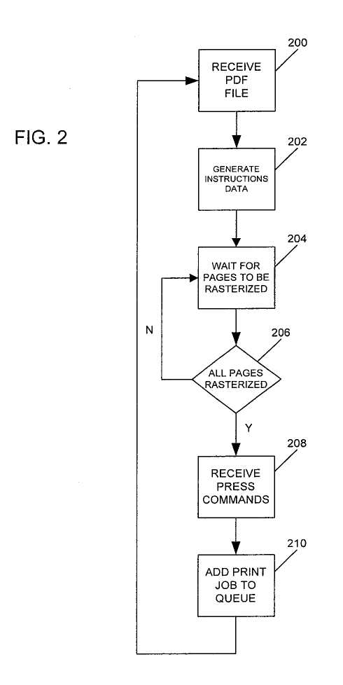

FIG. 2 shows a flowchart of an embodiment of the print-on-command server 102 that may be used by the printing system 100. A block 200 receives a PDF file from a PDF file generator. A block 202 generates and sends instruction data for the print-server 106 and each of the RIPs 108-A through 108-N necessary to print the PDF file. In addition, the block 202 sends the PDF file to each of the RIPs 108-A through 108-N necessary to print the PDF file.

A block 204 waits a predetermined amount of time. After the predetermined amount of time has elapsed, a block 206 checks whether all of the pages of the PDF file in all of the colors needed by the printing press 114 have been rasterized. If all of the pages have been rasterized control passes to a block 208 otherwise control returns to the block 204 to wait once again. In some embodiments, instead of waiting a predetermined time, the block 204 waits until a signal is received from one of the RIPs 108-A through 108-N that a page has been rasterized thereby.

A block 208 sends a signal to the print-server 106 that the job is ready to be printed (i.e., that all of the pages for the job have been rasterized).

After sending the job ready signal to the print-server 206, the block 208 returns to the block 200 to await an additional PDF file that is to be processed.

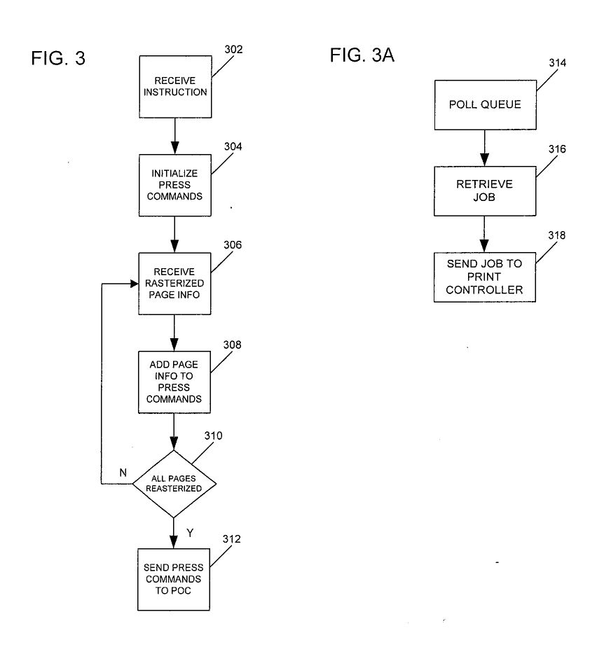

FIG. 3 illustrates an embodiment of a print-server 106. A block 302 receives print server instruction data from the print-on-command server 102 associated with a particular PDF file. A block 304 receives the PDF file that is to be printed. A block 306 generates press commands in accordance with the instruction data and the PDF file as described above. A block 308 waits for the signal from the print-on-command server 102 indicating that the job is ready to be printed. A block 310 creates a job from the print commands and adds such job to the print queue 116.

FIG. 3A shows a flowchart of a queue manager that sends data to the press controller 112. A block 314 polls the queue and selects a print job request from the queue. A block 316 retrieves the print job request from the queue. A block 318 retrieves and sends the press commands comprising the print job request to the press controller 112. In some embodiments the queue manager operates on the same computer as the print-server. In other embodiments, the queue manager operates on the same computer as the print-on-command system. In still other embodiments, the queue manager operates on a computer dedicated thereto.

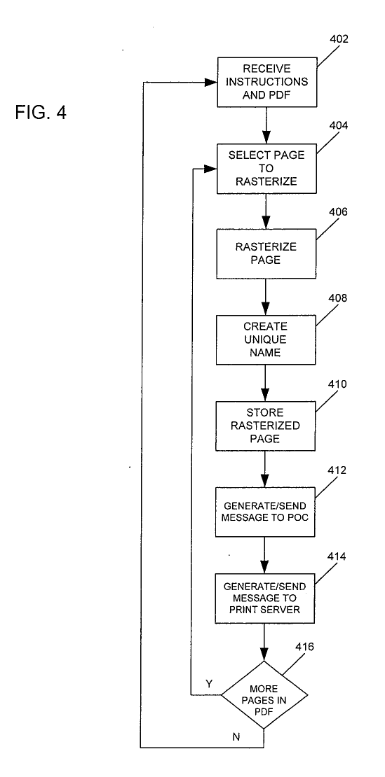

FIG. 4 shows a flowchart of an embodiment of one of the RIPs 108-A through 108-N. A block 402 receives RIP instruction data and the PDF that is to be rasterized. A block 404 selects a page to rasterize. A block 406 rasterizes the page selected by the block 404. A block 408 determines a unique name for a file in which raster data generated from the page is to be stored as described hereinabove. A block 410 stores the raster data in the file with the unique name. A block 412 generates and sends a message to the print-on-command 102 server that the page has been rasterized. A block 414 generates and sends a message to the print server that the page has been rasterized. A block 416 determines if all of the pages have been rasterized. If pages remain to be rasterized control passes from the block 416 to the block 404. Otherwise, control passes to the block 402, which waits for another PDF file and additional RIP instruction data to be received.

In some embodiments, one set of print commands are generated for each PDF file that is printed by the printing press 114, wherein the set directs the press to print all of the pages of the PDF file. In other embodiments, one set of print commands are generated for a subset of pages of a PDF file, wherein the set directs the printing press 114 to print the subset of pages represented by the print commands. For example, if a PDF file comprises 1000 pages, such PDF file may be printed using one set of press commands. Alternately, such PDF file may be printed using a first and a second set of press commands, wherein the first set directs the printing press 114 to print the first 500 pages from the PDF file and the second set directs the press to print the remaining 500 pages from the PDF file. In some embodiments, the number of pages that are represented by a set of press commands is provided in instruction data generated by the print-on-command server 102. Furthermore, if multiple sets of press commands are to be generated to print one PDF file, the PDF file may be sent to each of the RIPs 108-A through 108-N only once and the instruction data may instruct the RIPs 108-A through 108-N and the print-server the number of pages to include in each set of press commands. Alternately, instruction data may be sent separately to each RIP 108-A through 108-N and the print-server 106 for each set of press commands that are to be generated.

FIG. 5 illustrates one embodiment of the printing system shown in FIG. 1 and like reference numbers in FIG. 5 correspond to identical elements of FIG. 1.

Some printing presses 114 may include print units that are able to print more than one color. In such presses, print commands are generated for each print unit. For example, a printing press 114 that prints four colors (cyan, magenta, yellow, and black) may be comprised of two print units, wherein a first print unit prints cyan and magenta and a second print unit prints yellow and black. When used with such printing presses, each RIP 108-A through 108-B may be configured to generate raster data for two colors. For example, the RIP 108-A may generate raster data that represents cyan and magenta colors in a page of a PDF file and the RIP 108-B may generate raster data that represents yellow and black colors of such page. In such cases, the files, and the unique identifier corresponding thereto, generated by each RIP 108-A through 108-N comprises raster data generated by the RIP 108-A through 108-N for both colors.

In some embodiments, the PDF file may have metadata embedded therein that specify the folio number of each page in the PDF file. In addition, the PDF file may have metadata embedded therein that specify which pages of the PDF file are to be combined into one unit (such as a booklet). Metadata also may be embedded in the PDF file that provides instructions to the printing press 114 or finishing equipment (e.g., cutters, binders, stitchers, etc) associated therewith. Such metadata may be extracted from the PDF file, formatted, and included as part of the press commands that are sent to the press controller 112. In some embodiments, the press controller 122 may configure the printing press 114 or the finishing equipment in accordance with such metadata. The metadata regarding folio numbers of pages may be used by the print-on-command server 102 to identify in the instructions generated thereby the pages that are to be rasterized by the RIPs 108-A through 108-N.

The print system 100 described herein above may be configured so that the print-server 106 and RIPs 108-A through 108-N rasterize the pages of a PDF file while the pages from another PDF previously rasterized are being sent to the press controller 112 for printing.

### INDUSTRIAL APPLICABILITY

The present invention is particularly useful for use with high-speed and/or high-volume printing applications such as commercial printing, variable printing, statement printing, and the like. Additional uses are also contemplated and the invention is not limited to any particular use or embodiment described herein. Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. A system for rasterizing pages in a page description language file, the system comprising:
a first RIP and a second RIP; and
a server that sends the page description file and instruction data to the first RIP and the second RIP;
wherein the first RIP rasterizes a first portion of the pages in the page description language file and the second RIP rasterizes a second portion of the pages in the page description language file, wherein the first portion and the second portion are selected in accordance with the instruction data.

2. The system of claim 1, wherein the page description language file is a Postscript file.

3. The system of claim 1, wherein the page the page description language file is a PDF file.

4. The system of claim 1, wherein the first RIP generates a raster image for each page in the first portion and a unique name is associated with each raster image.

5. The system of claim 1, wherein a storage device is associated with the first RIP.

6. The system of claim 5, wherein the first and the second RIPs generate first and second raster images, respectively, and stores such raster image on the storage device.

7. The system of claim 1, wherein the system comprises a print server and a press controller, wherein the print server generates press commands that are sent to the press controller.

8. The system of claim 7, wherein the press commands include a reference to a rasterized image associated with a page, wherein the first or the second RIP generates the rasterized image.

9. The system of claim 8, wherein the press controller retrieves a raster image generated by the first or the second RIP from the storage device associated with such RIP.

10. The system of claim 1, wherein the first RIP transmits a notification to the server upon completing rasterizing of a page comprising the first portion.

11. The system of claim 10, wherein the notification includes a unique name associated with a raster image associated with the page.

12. A method for rasterizing pages in a page description language file, the method comprises the steps of:
sending the page description language file and instruction data to a first RIP and a second RIP;
operating the first RIP to rasterize a first portion of the pages in the page description language file in accordance with the instruction data; and
operating the second RIP to rasterize a second portion of the pages in the page description language file in accordance with the instruction data.

13. The method of claim 12, wherein the page description language file is a Postscript file.

14. The method of claim 12, wherein the page description language file is a PDF file.

15. The method of claim 12, wherein the step of operating the first RIP comprises the step of generating a raster image for each page in the first portion and the step of associating a unique name with each raster image.

16. The method of claim 12, wherein the step of operating the second RIP comprises the step of generating a raster image and the step of storing such raster image on a storage device associated with the first RIP.

17. The method of claim 12, further comprising the step of generating press commands that are sent to a press controller.

18. The method of claim 17, wherein the step of generating the press commands comprises the step of including a reference to a rasterized image generated by the first RIP or the second RIP in the press commands.

19. The method of claim 18, further comprising the step of operating the press controller to retrieve a raster image generated by the first or the second RIP from a storage device associated with such RIP.

20. The method of claim 12, wherein the step of operating the first RIP comprises the step of transmitting a notification to the server upon completing rasterizing of a page comprising the first portion.

21. The method of claim 20, wherein the notification includes a unique name associated with a raster image associated with the page.
